(19) United States
(12) Patent Application Publication
(10) Pub. No.: US 2025/0300471 A1
(43) Pub. Date: Sep. 25, 2025

(54) CHARGING AND DISCHARGING METHOD FOR UNIVERSAL SERIAL BUS INTERFACE AND ELECTRONIC DEVICE

(71) Applicant: Nanning FuLian FuGui Precision Industrial Co., Ltd., Nanning (CN)

(72) Inventor: ZHU-LIN HUANG, Shenzhen (CN)

(21) Appl. No.: 18/987,068

(22) Filed: Dec. 19, 2024

(30) Foreign Application Priority Data
Mar. 22, 2024 (CN) 202410339058.2

(51) Int. Cl. H02J 7/00

(52) U.S. Cl. CPC H02J 7/0036; H02J 2207/30

(57) ABSTRACT

In a charging and discharging method for universal serial bus interface and an electronic device, whether a data line with dual universal serial bus connectors is connected to the electronic device is detected by a detection circuit; when the data line with dual universal serial bus connectors is detected to be connected to the electronic device, whether a voltage bus at one end of the data line connected to the electronic device has a voltage is determined; when the voltage bus at one end of the data line connected to the electronic device has no voltage is detected, role of the electronic device is assigned as a discharge device for discharging; and when the voltage bus at one end of the data line connected to the electronic device has the voltage is detected, the role of the electronic device is assigned as a charging device for charging.

### CROSS-REFERENCE TO RELATED APPLICATIONS

This application claims priority to Chinese Patent Application No. 202410339058.2 filed on Mar. 22, 2024, in China National Intellectual Property Administration, the contents of which are incorporated by reference herein.

### FIELD

The subject matter herein generally relates to charging and discharging technology, in particular to a charging and discharging method for universal serial bus interface and an electronic device.

### BACKGROUND

With the development of technology, more and more embedded products support the dual roles of Type-C, such as mobile phones or tablets, which can provide power and data transmission as a host (Source), and can also receive power and data as a slave device (Sink).

Since both device A and device B support dual Type-C roles, when the two devices are connected using a cable with dual Type-C connectors, the roles of the two devices are not assigned. For example: when we want device A to charge device B, in fact, device B successfully seizes the host, and device B charges device A in turn (this is an unexpected scenario), or the role of device A and device B is not assigned and a power cycle occurs.

### BRIEF DESCRIPTION OF THE DRAWINGS

Implementations of the present technology will now be described, by way of example only, with reference to the attached figures, wherein:

FIG. 1 is a program module diagram illustrating an electronic device according to an embodiment of the present disclosure; and

FIG. 2 is a flowchart illustrating a charging and discharging method for an universal serial bus interface according to an embodiment of the present disclose.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

References to “an” or “one” embodiment in this disclosure are not necessarily to the same embodiment, and such references mean “at least one”.

In general, the word “module” as used herein after, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

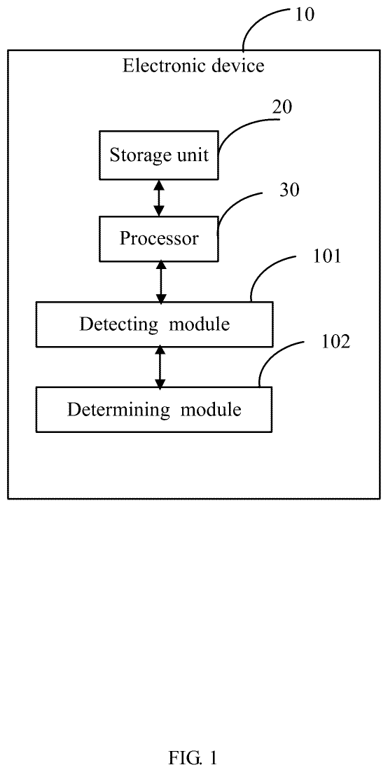

FIG. 1 illustrates a program module diagram of an electronic device 10 according to a preferred embodiment of the present disclose.

The electronic device 10 includes a detecting module 101 and a determining module 102. The electronic device 10 further includes a storage unit 20, and a processor 30. The modules are configured to be executed by one or more processors (in the in the preferred embodiment, a number of the one or more processors 30 is one). The modules referred to are computer program segments that perform specific instructions. The storage unit 20 is used to store program code and other data of the electronic device 10. The processor 30 is used to execute the program code stored in the storage unit 20.

The storage unit 20 includes at least one type of readable storage medium, the readable storage medium includes a flash memory, a hard disk, a multimedia card, a card-type memory (for example, SD or DX memory, etc.), a random access memory (RAM), a static random access memory (SRAM), a read only memory (ROM), an electrically erasable programmable read only memory (EEPROM), a programmable read only memory (PROM), a magnetic memory, a magnetic disk, an optical disk, and other components. The processor 30 may be a central processing unit (CPU), a controller, a microcontroller, a microprocessor, or other data processing chip.

The detecting module 101 detects whether a data line with dual universal serial bus connectors is connected to the electronic device by a detection circuit.

In the embodiment, the electronic device 10 is a chargeable and dischargeable device with a universal serial bus interface. The electronic device 10 provides charging for other electronic devices and can also be charged by other electronic devices. For example, the electronic device can be a mobile phone, a tablet, a mobile power supply and so on. For example, a data line with dual USB connectors can be a dual Type-C data line.

Specifically, the detecting module 101 detects high and low level changes of the detection circuit, and determines the data line connected to the electronic device 10 when the detection circuit changes from a high level to a low level.

In the embodiment, the detection circuit is equivalent to a physical switch. When the electronic device 10 is not connected to the data line with dual universal serial bus connectors, the metal ground shell of the detection circuit and detection pins are not in contact, and the detection pins are pulled to ICC and maintain a high level. When the electronic device 10 is connected to the data line, due to the physical space relationship, the metal contact piece of the detection pins is squeezed into contact with the metal ground shell, and the detection pins are short-circuited to the ground and become a low level. Therefore, once the high and low level signals change, whether there is a data line connected can be determined.

When the detecting module 101 detects that a data line is connected, the determining module 102 determines whether voltage bus at one end of the data line connected to the electronic device has a voltage. If not, it indicates that there is data from dual universal serial bus connectors. One end of the line is connected to the electronic device 10, and the other end is not connected to any electronic device, that is, the other end is not connected to power. Then it can be known that one end of the data line with dual universal serial bus connectors is connected first. At this time, the electronic device 10 is assigned as a discharge device for discharging. For example, when the data lines with dual universal serial bus connectors are dual Type-C data lines, the voltage bus connected to one end of the data line to the electronic device 10 is VBUS of the Type-C interface.

When the detection circuit detects that a data line is connected, whether voltage bus at one end of the data line connected to the electronic device has a voltage is determined. If not, it indicates that there is data from dual universal serial bus connectors. One end of the line is connected to the electronic device 10, and the other end is not connected to any electronic device, that is, the other end is not connected to power. Then it can be known that one end of the data line with dual universal serial bus connectors is connected first. At this time, the electronic device 10 is assigned as a discharge device for discharging. For example, when the data lines with dual universal serial bus connectors are dual Type-C data lines, the voltage bus connected to one end of the data line to the electronic device 10 is VBUS of the Type-C interface.

When the other end of the data line with dual universal serial bus connectors is connected to the device, both ends of the data line with dual universal serial bus connectors are connected to the device, and a closed loop is formed. Therefore, the voltage bus already exists voltage, then the role of the electronic device 10 connected later is assigned as a charging device for charging.

In the embodiment, the detection circuit can be used to detect whether the other end of the data line with dual universal serial bus connectors is connected to an electronic device. When it is connected to an electronic device and no electronic device is connected to the other end, it is also possible to explicitly assign roles between devices by just assigning the role at one end, so that they remain consistent during the connection process.

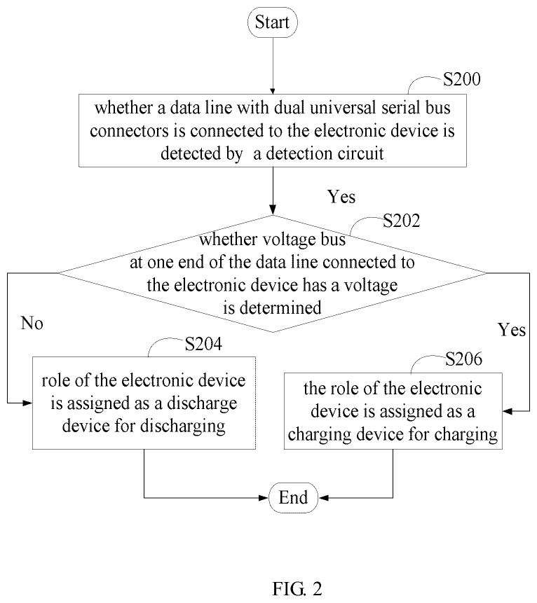

FIG. 2 illustrates a flowchart presented in accordance with an embodiment of a charging and discharging method for universal serial bus interface 2000. Each block shown in FIG. 2 represents one or more processes, methods, or subroutines, carried out in the exemplary method 2000. Additionally, the illustrated order of blocks is by example only and the order of the blocks can be changed. The method 2000 can begin at block 200.

At block S200, whether a data line with dual universal serial bus connectors is connected to the electronic device is detected by a detection circuit.

In the embodiment, the electronic device 10 is a chargeable and dischargeable device with a universal serial bus interface. The electronic device 10 provides charging for other electronic devices and can also be charged by other electronic devices. For example, the electronic device can be a mobile phone, a tablet, a mobile power supply and so on. For example, a data line with dual USB connectors can be a dual Type-C data line.

Specifically, in the block S200: high and low level changes of the detection circuit is detected, and the data line is determined to connected to the electronic device 10 when the detection circuit changes from a high level to a low level.

In the embodiment, the detection circuit is equivalent to a physical switch. When the electronic device 10 is not connected to the data line with dual universal serial bus connectors, the metal ground shell of the detection circuit and detection pins are not in contact, and the detection pins are pulled to ICC and maintain a high level. When the electronic device 10 is connected to the data line, due to the physical space relationship, the metal contact piece of the detection pins is squeezed into contact with the metal ground shell, and the detection pins are short-circuited to the ground and become a low level. Therefore, once the high and low level signals change, whether there is a data line connected can be determined.

At block S202, when the data line with dual universal serial bus connectors is detected to be connected to the electronic device, whether voltage bus at one end of the data line connected to the electronic device has a voltage is determined. When detecting the voltage bus at one end of the data line connected to the electronic device has no voltage, block 204 is executed, and when determining that the voltage bus at one end of the data line connected to the electronic device has the voltage, block 206 is executed.

At block S204, role of the electronic device is assigned as a discharge device for discharging; and

At block S206, the role of the electronic device is assigned as a charging device for charging.

When the detection circuit detects that a data line is connected, whether voltage bus at one end of the data line connected to the electronic device has a voltage is determined. If not, it indicates that there is data from dual universal serial bus connectors. One end of the line is connected to the electronic device 10, and the other end is not connected to any electronic device, that is, the other end is not connected to power. Then it can be known that one end of the data line with dual universal serial bus connectors is connected first. At this time, the electronic device 10 is assigned as a discharge device for discharging. For example, when the data lines with dual universal serial bus connectors are dual Type-C data lines, the voltage bus connected to one end of the data line to the electronic device 10 is VBUS of the Type-C interface.

When the other end of the data line with dual universal serial bus connectors is connected to the device, both ends of the data line with dual universal serial bus connectors are connected to the device, and a closed loop is formed. Therefore, the voltage bus already exists voltage, then the role of the electronic device 10 connected later is assigned as a charging device for charging.

In the embodiment, the detection circuit can be used to detect whether the other end of the data line with dual universal serial bus connectors is connected to an electronic device. When it is connected to an electronic device and no electronic device is connected to the other end, it is also possible to explicitly assign roles between devices by just assigning the role at one end, so that they remain consistent during the connection process.

The embodiments shown and described above are only examples. Many details are often found in the art such as the other features of charging and discharging method for universal serial bus interface. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A charging and discharging method for universal serial bus interface, applied to an electronic device which has a universal serial bus interface, the charging and discharging method comprising:
detecting whether a data line with dual universal serial bus connectors is connected to the electronic device by a detection circuit, wherein the electronic device is a chargeable and dischargeable device;
when the data line with dual universal serial bus connectors is detected to be connected to the electronic device, determining whether a voltage bus at one end of the data line connected to the electronic device has a voltage;
when the voltage bus at one end of the data line connected to the electronic device is detected to has no voltage, assigning a role of the electronic device as a discharge device for discharging; and
when that the voltage bus at one end of the data line connected to the electronic device is detected to has the voltage, assigning the role of the electronic device as a charging device for charging.

2. The charging and discharging method for universal serial bus interface according to claim 1, wherein whether the data line with dual universal serial bus connectors is detected to be connected to the electronic device by the detection circuit comprises:
detecting high and low level changes of the detection circuit; and
determining the data line is connected to the electronic device when the detection circuit changes from a high level to a low level.

3. An electronic device, which includes a non-transitory memory storage, a processor, and a universal serial bus interface charging and discharging program stored in the non-transitory memory storage and operable on the processor, wherein the universal serial bus interface charging and discharging program is executed by the processor to implement following functions:
detecting whether a data line with dual universal serial bus connectors is connected to the electronic device by a detection circuit, wherein the electronic device is a chargeable and dischargeable device;
when the data line with dual universal serial bus connectors is detected to be connected to the electronic device, determining whether a voltage bus at one end of the data line connected to the electronic device has a voltage;
when the voltage bus at one end of the data line connected to the electronic device is detected to has no voltage, assigning a role of the electronic device as a discharge device for discharging; and
when that the voltage bus at one end of the data line connected to the electronic device is detected to has the voltage, assigning the role of the electronic device as a charging device for charging.

4. The electronic device according to claim 3, wherein when whether the data line with dual universal serial bus connectors is detected to be connected to the electronic device by the detection circuit, the universal serial bus interface charging and discharging program is further executed by the processor to implement following functions:
detecting high and low level changes of the detection circuit; and
determining the data line is connected to the electronic device when the detection circuit changes from a high level to a low level.
